(19) United States
(12) Patent Application Publication
(10) Pub. No.: US 2024/0301119 A1
(43) Pub. Date: Sep. 12, 2024

(54) IMPROVED POLYMER BARRIER MATERIAL FOR PLASTIC PACKAGINGS

(71) Applicant: RESILUX N.V., Wetteren (BE)

(72) Inventors: Dirk DE CUYPER, Wetteren (BE); William DIERICKX, Wetteren (BE); Pieterjan LENAIN, Wetteren (BE); Tom ANTHIERENS, Wetteren (BE); Joke DE GEETER, Wetteren (BE); Lucie IMBERNON, Wetteren (BE)

(21) Appl. No.: 17/926,317

(22) PCT Filed: May 18, 2021
(86) PCT No.: PCT/IB2021/054272

§ 371 Date: Nov. 18, 2022

(30) Foreign Application Priority Data
May 20, 2020 (BE) BE 2020/5353

(51) Int. Cl. C08G 18/12; B29C 49/00; B29C 49/04; B29K 75/00; B29K 101/12; B29L 31/00; C08G 18/32; C08L 75/04

(52) U.S. Cl. CPC C08G 18/12; B29C 49/0005; B29C 49/04; C08G 18/3206; C08L 75/04; B29K 2075/00; B29K 2101/12; B29K 2995/0067; B29L 2031/7158; C08L 2201/14; C08L 2203/16; C08L 2203/30

(57) ABSTRACT

A thermoplastic polyurethane obtained from a reaction mixture comprising: (a) at least one cyclic polyisocyanate, and (b) at least one polyol, in which the thermoplastic polyurethane has gas barrier characteristics which are better than the gas barrier characteristics of polyethylene terephthalate (PET) measured under the same circumstances, wherein the thermoplastic polyurethane is an essentially amorphous material based on the absence of a melting peak in a DSC curve, and the thermoplastic polyurethane has a glass transition temperature Tg situated between 60° C. and 99.5° C. in a DSC curve, and both curves were obtained with differential scanning calorimetry (DSC) as mentioned in the description. Hollow and hard bottles can be obtained from this material and as well as methods for obtaining the material and bottles.

### TECHNICAL FIELD

The invention is situated in the domain of hard, plastic packagings with gas barrier characteristics. The invention is important for the protection of oxidation sensitive products, such as fruit juices and beers. The invention is also important for the long-term storage of CO2-containing drinks, such as beers and soft drinks.

### BACKGROUND

Hollow, hard packagings made of polyethylene, polypropylene or polyester are generally known. A typical hollow and hard packaging product are bottles. Within the bottle segment, bottles made from polyethylene terephthalate (PET) are a successful packaging product.

In a standard PET bottle, fruit juice only has a shelf life of 2 to 3 months. This is due to the less beneficial barrier characteristics of standard PET with respect to oxygen. When oxygen penetrates into a bottle with a food product, the oxygen can enhance the development of moulds and aerobic bacteria, and the oxygen can oxidise the food product resulting in quality loss. PET also has less beneficial barrier characteristics with respect to carbon dioxide (CO2). The shelf life of beer in a standard PET bottle is only 10 to 12 weeks, as a result of the gradual loss of CO2 from the CO2-containing drink composition.

For improving the gas barrier characteristics of PET, different systems are used. They can be divided into three categories: active or passive barriers of a combination of both.

A passive barrier is a film which is less permeable than PET and, in this way, blocks migration of O2 or CO2. Known examples are MXD6 nylon, polyvinyl alcohol (PVOH) and polyethylene naphthalate (PEN), ethylene-vinyl alcohol (EVOH), polyamid-6 nylon.

An active barrier is for example formed by a polymer composition in which a metal catalyser was mixed acting as a chemical O2 scavenger. At present, there is no active barrier for CO2. A well-known active O2 barrier composition consists of a combination of MXD6 nylon and cobalt. An active barrier is more performant as the O2 migration than a passive barrier from the same polymer since the oxygen is linked actively here instead of only physically retained. By adding catalysers, active barriers are, however, mostly more expensive.

A barrier can be applied in a bottle in different ways. The bottle with barrier can consist of a monolayer, a multi-layer, or a bottle provided with a coating.

A mono-layer bottle is made of a preform fabricated with a blend of thermoplastic plastic and a barrier material. This system is only appropriate for active barriers. The efficiency of the O2 scavenger depends on the dilution in the plastic material layer. A monolayer is mostly applied for short-term storage of about 3 months. In order to obtain a longer shelf life, large amounts of barrier material have to be added. This makes the preform and the bottle hazy and expensive. An additional problem is that the barrier material is in direct contact with the content of the bottle. In case of a food product, food safety is required.

A multi-layer construction is obtained by inserting a core layer of barrier material between two structural PET layers by means of co-injection when injecting the preform. The core layer can only consist of barrier material. In this case, a passive barrier is used. When a blend of thermoplastic polymer and a catalyser is used as a core layer, an active barrier is used. The advantage of a multi-layer construction compared to a mono-layer construction is that the battier material is more concentrated locally and thus has a larger efficiency. Hence, less barrier material is required. For the construction of multi-layer bottles, however, a more expensive and more complex production process is required.

A third possibility is the application of a coating layer with barrier material on the inside or outside of the bottle. Barrier materials used in coatings are for example silicon dioxide, abbreviated as SiO2, and carbon. A coating process is only used for passive barriers.

The use of nylon as a barrier material in PET bottles is well-known. A frequently used material is Nylon-MXD6, a polyamide produced from m-xylene diamine (MXDA) by Mitsubishi Gas Chemical Co.

The nylon-MXD6 material is very appropriate for processing in injection moulding processes, such as the injection moulding of preforms for bottles, both for multi-layer and blend. The refractive index of the material is very close to the one of PET, as a result of which preforms and bottles of this material are still very clear and transparent.

The nylon-MXD6 material has, however, the disadvantage that it easily absorbs water making the material hazy. This results in a hazy preform and bottle. Moreover, the barrier characteristics deteriorate when the material absorbs fluid. This is problematic since PET is not completely permeable for water vapour.

Moreover, it is known that nylon-MXD6 material easily delaminates from PET. Also, the adhesion to polyolefin plastics, such as polyethylene (PE) and polypropylene (PP), is unsatisfactory. As a result, nylon-MXD6 cannot be used as a barrier material in combination with these polymers without using tie layers.

Barrier materials such as nylon-MXD6 and EVOH have limitations as to the mechanical recycling. Nylon-MXD6 for example will turn yellow during the recycling process and will thus negatively influence the clearness of the PET flow. The European PET Bottle Platform (www.epbp.org) gives limitations as to the use of these barrier materials in preforms for bottles. For example, maximum 5% of nylon-MXD6 can be used as an intermediate layer in a multi-layer preform. Blends of PET and nylon-MXD6 are excluded from the recycling process because of the haziness caused by nylon-MXD6 in PET blends. The use of more than 3% of EVOH in the intermediate layer of a multi-layer preform is also not compatible with the recycling flow of PET. These limitations thus form an obstacle for the use of these materials in preforms for bottles. This will probably only become more problematic in the future considering the general evolution to recycling of packaging materials.

Nylon-MXD6 additionally has the disadvantage that residual adipic acid, which is corrosive, damages the metal components of production installations. This results in high costs of maintenance.

A first initiative to improvement has been described in BE 2015/0199, a previous patent application of the present applicant. BE 2015/0199 discloses hollow, hard packaging materials with two candidates of barrier materials based on a thermoplastic polyurethane (TPU) with ring structures. A first TPU barrier material is based on the aromatic ring structure coming from the monomer metaxylene diisocyanate, MXDI. A second TPU barrier material is based on the aliphatic ring structure coming from the monomer cyclohexyl diisocyanate, CHDI. In a subsequent application WO2017008129, thermoplastic polyurethane materials were disclosed with a melting point situated between 110° C. and 160° C. A melting temperature is by definition the temperature at which the crystalline order is destroyed. Thus, this are crystalline materials. The compatibility of the above-mentioned materials with PET in an industrial production process for plastic bottles is however not sufficient. Too many bottles with the new material break in an injection moulding-(stretch)blow moulding process. Also, the production cost is still too high for a large-scale use.

U.S. Pat. No. 8,394,501 relates to polyurethane materials and its use in coatings, films, adhesives. No information is given about glass transition temperatures or crystallinity of the materials; neither about the behaviour of the materials in an injection moulding process for fabricating packaging preforms or in a stretch blow moulding treatment for the production of containers.

JP2014046678 relates to the coating of a plastic container with a gas barrier PU coating. No information is given about glass transition temperatures or crystallinity of the materials, or the action of the materials as a layer in a preform or bottle.

EP2103640 discloses gas barrier materials for packagings. The building stones therefore are a polymer of the polycarboxylic acid type (A) and a bifunctional alicyclic epoxy compound (B). A polymer of the urethane type can form an anchoring layer in a laminate structure. The adhesive of the urethane type is not part of the barrier. It was not characterised with respect to the glass transition temperature or crystalline character. No information was given about the processibility of the materials as a layer in an injection moulding process, blow moulding process, production of a preform or a bottle.

There is a clear need of further improvements.

The invention aims to find a solution for one or more of the above-mentioned problems. Specifically, the invention aims to provide a material with gas barrier characteristics. The invention aims to provide a gas barrier material which stays clear at water absorption and has no loss in barrier characteristics at high humidity (>85% of relative humidity). The invention aims to provide a gas barrier material which has a good adhesion to PET, and preferably also to other plastics used for the fabrication of packagings such as PE and PP. The invention further aims to provide a gas barrier material which is not based on corrosive raw materials in order to avoid damage to production machines. The invention aims to provide a gas barrier material which has better characteristics than MXD6-nylon barrier material, especially for increasing the shelf life of food packaged in bottles with the new barrier material. The invention aims to provide bottles with the gas barrier material with a good recycling capacity and a low cost price.

### SUMMARY OF THE INVENTION

The invention provides an improved thermoplastic polyurethane (TPU) material with gas barrier characteristics according to claim 1 for use in hollow, hard packaging materials such as bottles. The invention also provides a method for the production of said TPU material and bottles or films comprising the TPU material, respectively, according to claims 16, 22 and 26. Furthermore, the invention provides hollow, hard bottles and films provided with the improved gas barrier material, according to claim 11. Preferred embodiments have further been described in the dependent claims.

### DESCRIPTION OF THE FIGURES

FIG. 1 shows a graphical illustration of the glass transition temperature of a thermoplastic polyurethane obtained from the reaction of a mixture comprising the at least one cyclic polyisocyanate MDI and at least one polyol.

FIG. 2 shows a graphical illustration of the glass transition temperature of a thermoplastic polyurethane obtained from the reaction of a mixture comprising the polyol diethylene glycol (DEG) and at least one cyclic polyisocyanate.

FIG. 3 shows a graphical illustration of the barrier characteristics of different TPUs according to the invention compared to a reference for PET and a MXD6-nylon comparison material.

FIG. 4 shows a graphical illustration of a DSC curve, taken with differential scanning calorimetry on a TPU according to an embodiment of the invention.

FIG. 5 shows a photographic illustration of a bottle comprising a TPU according to the invention compared to a preform comprising a TPU not according to the invention, which could not be blown into a bottle and burst.

FIG. 6 shows a photographic illustration of a bottle comprising a PET/TPU blend according to the invention compared to a bottle comprising a PET/nylon-MXD6 blend.

FIG. 7 shows a graphical illustration of the humidity-dependent oxygen permeability of different polymers at 23° C.

FIG. 8 shows a graphical illustration of the oxygen permeability of different polymers at high humidity and 23° C.

### DETAILED DESCRIPTION OF THE INVENTION

Unless otherwise specified, all terms used in the description of the invention, including technical and scientific terms, shall have the meaning as they are generally understood by the worker in the technical field the present invention relates to. Furthermore, definitions of the terms have been included for a better understanding of the description of the present invention.

As used here, the following terms shall have the following meaning: “A”, “an” and “the”, as used here, refer to both the singular and the plural form unless clearly understood differently in the context. For example, “a compartment” refers to one or more than one compartment.

“Approximately” as used here, that refers to a measurable value such as a parameter, a quantity, a period or moment, etc., is meant to include variations of +/−20% or less, preferably +/−10% or less, more preferably +/−5% or less, still more preferably +/−1% or less, and even still more preferably +/−0.1% or less of the cited value, as far as such variations are appropriate for realizing the invention that is described. It will however be clear that the value to with the term “approximately” relates, will also be described specifically. The terms “include”, “including” and “included”, as used here, are inclusive of open terms that indicate the presence of what follows e.g. a component, and that do not exclude the presence of additional, non-said components, characteristics, elements, members, steps, that are well-known from or described in the state of the art.

The citation of numeric intervals by means of end points includes all integers and fractions included within that interval, including these end points.

The term “w/w %” as used here, refers to a weight percentage in which the ratio of the weight of an ingredient to the total weight of a bottle without a closing means, is expressed as a percentage. A synonym is mass percentage.

In a first aspect, the invention provides
a thermoplastic polyurethane obtained from a reaction mixture comprising:
   (a) at least one cyclic polyisocyanate, and
   (b) at least one polyol,
in which the thermoplastic polyurethane has gas barrier characteristics which are better than the gas barrier characteristics of polyethylene terephthalate (PET) measured under the same circumstances,
characterised in that
the thermoplastic polyurethane is an essentially amorphous material based on the absence of a melting peak in a DSC curve, and
the thermoplastic polyurethane has a glass transition temperature Tg situated between 60° C. and 99.5° C. in a DSC curve, and
both curves were obtained with differential scanning calorimetry (DSC) as mentioned below.

The glass transition temperature and the determination of the amorphous character of the thermoplastic polyurethane were determined with differential scanning calorimetry (DSC). DSC is a measuring technique in which a sample and a reference are heated and/or cooled at a pre-set speed, in which the difference in heat flows to the sample and reference are measured. The sample is a thermoplastic polyurethane according to an embodiment of the invention. The reference is an empty sample pan.

The used measuring protocol for registering the DSC curve was as follows:
weighing of a 10-20 mg thermoplastic polyurethane sample,
stabilisation of the sample and the reference at 20° C. for 10 minutes,
heating from 20° C. to 250° C. at a heating speed of 10° C./min,
stabilisation for 2 minutes at 250° C.,
cooling from 250° C. to 20° C. at a cooling speed of −10° C./min.
stabilisation for 2 minutes at 20° C.
heating from 20° C. to 300° C. at a heating speed of 10° C./min.

At least two heating scans were taken. The value of the glass transition temperature was read from the second heating scan in order to avoid possible thermal history and a possible impact of the presence of water. The tangent lines to the DSC curve above and under the glass transition are determined. The section of an imaginary parallel line at equal distance between the two previous tangent lines, with the DSC curve, determines the glass transition temperature (midpoint).

In the registered DSC curve, the presence of a melting peak in the second curve was missing (see description measuring method). This indicates a low degree of crystalline structure in the material, or in other words, an essentially amorphous material. The highly amorphous character of the thermoplastic polyurethane material is advantageous for the use in applications in which a transparent material is desired, such as in the production of bottles.

The inventors have established by experiment that the above-described material has an improved behaviour in injection (stretch) blowing applications. The gas barrier material breaks less easily than material known from the state of the art. The material has an improved processability, especially in an injection (stretch) blow moulding application (I(S)BM).

The thermoplastic polyurethane is characterized by a glass transition temperature Tg situated between 60° C. and 99.5° C. The thermoplastic polyurethane according to an embodiment of the invention preferably has a glass transition temperature Tg situated between 65° C. and 99° C., more preferably situated between 70° C. and 98° C., still more preferably situated between 75° C. and 97° C., most preferably situated between 85° C. and 96° C.

This range has the advantage that the material has a Tg which is close to the Tg of PET. For comparison, the Tg for amorphous PET is 67° C. and for crystalline PET 80-81° C.

For obtaining the glass transition temperature within the target range, the inventors have preferably used a polyol mixture. Polyols were preferably selected from the list of ethylene glycol, propane diol, butane diol, pentane diol, hexane diol, glycerol, diethylene glycol, triethylene glycol, tetra ethylene glycol, polycarbonate diol, 1,4-cyclohexane dimethanol, poly(tetramethylene ether) glycol (PTMEG).

The polyols in the mixture preferably all had a relatively low molecular weight, situated between 100 g/mole and 200 g/mole. Polyols with a molecular weight situated between 100 g/mole and 200 g/mole appropriate for use in the present invention are diethylene glycol, triethylene glycol or tetraethylene glycol.

Said reaction mixture preferably comprises not more than two polyols with a molecular weight situated between 100 and 200 g/mole. This has the effect that the mixture is well verifiable and easy. Two polyols can be dosed easily. The choice of only two polyols has the advantage that the polydispersity does not get too high. This is advantageous for an easy extrusion of the TPU material.

Said not more than two polyols with a molecular weight situated between 100 and 200 g/mole are preferably diethylene glycol and triethylene glycol. Both polyols were tested, as well as different ratios of DEG and TEG. A DEG:TEG mass ratio of 70:30 is mostly preferred. The result of such a ratio is an optimum between barrier characteristics and processability for a bottle production.

A thermoplastic polyurethane according to an embodiment of the invention is based on at least one cyclic polyisocyanate.

In a preferred embodiment, the at least one cyclic polyisocyanate is an aromatic polyisocyanate. Preferably, the aromatic polyisocyanate is not 1,3-xylene diisocyanate (MXDI).

Most preferably, the aromatic polyisocyanate is 4,4′-methylene diphenyl-diisocyanate, abbreviated as MDI or 2,4′-methylene diphenyl diisocyanate, abbreviated as 2,4′-MDI.

In a preferred embodiment, the at least one cyclic polyisocyanate is an aliphatic polyisocyanate. Preferably, the cyclic polyisocyanate is not cyclohexane diisocyanate (CHDI). Preferably, the cyclic polyisocyanate is isoforon diisocyanate (IPDI).

The polyisocyanate preferences result in oxygen and/or carbonic acid gas barrier characteristics and an interesting cost price of raw materials.

A thermoplastic polyurethane according to an embodiment of the invention is preferably obtained by reactive extrusion. This technique has the advantage that raw materials can be dosed and react very regularly, in small amounts. This is advantageous for minimising side reactions. The resulting product is characterised by a low content of side products. The resulting product is a nearly non-crosslinked polyurethane, as appears from the solubility in DMF, because of the very short residence time of the raw materials in the reaction.

The ratio of the stoichiometric amount of isocyanate groups to the stoichiometric number of isocyanate-reactive groups in said reaction mixture is preferably higher than 1. Preferably, the ratio is situated between 1.01 and 1.10. This ratio is advantageous for obtaining a material with desired flowing characteristics.

The flowing characteristics of a material can be quantified by means of the Melt Flow Index. The thermoplastic polyurethane according to an embodiment of the invention is preferably characterised by a Melt Flow Index between 10 and 45 g/10 min at 230° C., preferably situated between 15 and 40 g/10 min at 230° C., more preferably between 20 and 30 g/10 min at 230° C., most preferably approximately 25 g/10 min at 230° C.; measured at a test load of 2.16 kg. The MFI values are advantageous for a good processability of the TPU in a co-injection moulding/blowing process together with PET. TPU with these MFI values can be processed advantageously in multi-layer applications.

The melt flow index (MFI) of material is measured in gram per 10 minutes (g/10 min). Only MFI values measured under the same experimental circumstances can be used for comparison. The used parameters are:

| Amount of sample | 6 | g |
|---|---|---|
| Setpoint temperature | 230° | C. |
| Test load | 2.160 | kg |
| Pre-heating time | 150 | sec |
| Heating position | 56 | mm |
| Position/test time | 50 | mm |
| Number of extrudates | 6 | |
| Delta s/delta t | 5 | mm |
| Melting density | 1.100 | kg/m³ |

The thermoplastic polyurethane according to an embodiment of the invention is preferably substantially free from non-reacted polyisocyanate groups. This is necessary for use of the material in an application with direct food contact. The material has a good stability.

The absence of non-reacted polyisocyanate groups is based on the absence of an NCO signal in a Fourier Transform Infra Red (FTIR) analysis.

The FTIR analysis used for measuring thermoplastic polyurethane samples according to the present invention was as follows:

| | | |
|---|---|---|
| Scanning range | 4000-600 | cm−1 |
| Wavelength free NCO group | 2259 | cm−1 |

| | |
|---|---|
| Number of scans | 16 |
| Resolution | 4.000 |
| Amplification | 8.0 |

A thermoplastic polyurethane according to an embodiment of the invention preferably comprises not more than 40%, more preferably not more than 30%, more preferably not more than 20%, most preferably less than 10% of functional groups which are no urethane, alcohol or isocyanate groups. Preferably, the reaction mixture for the production of the thermoplastic polyurethane according to the invention, is 100% based on polyols and cyclic polyisocyanate.

Preferably, the gas barrier is an oxygen and CO2 gas barrier.

The term “barrier better than PET” in the present invention means a barrier better than 1.7 cc·mm/m2·day·atm at 23° C. and 60% RH for a 20 micrometer PET layer (reference: https://www.mgc.co.jp/eng/products/ac/nmxd6/barrier.html).

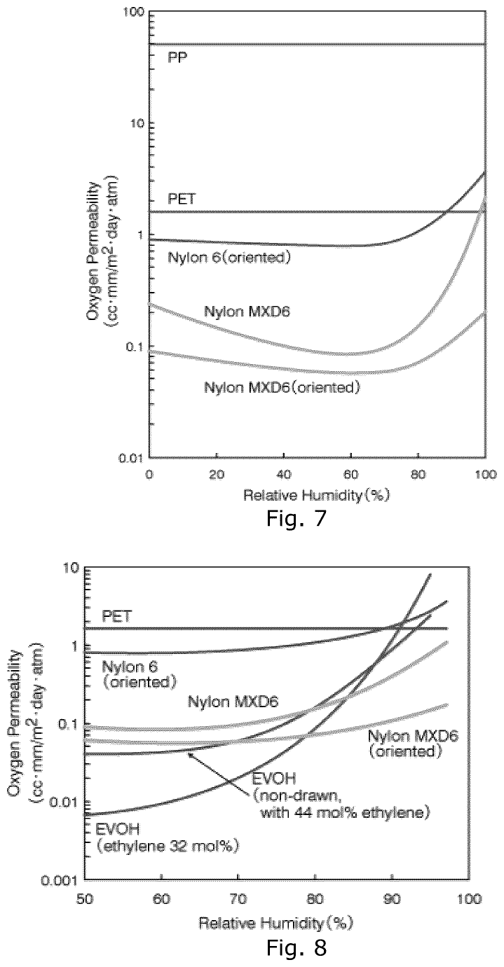

The comparative information as mentioned on said website page was added as additional FIGS. 7 and 9.

A thermoplastic polyurethane according to an embodiment of the invention, with a 20 micrometer thermoplastic polyurethane gas barrier layer preferably has an oxygen permeability of at most 1.6 cc·mm·m2·day·atm at 23° C. and 60% RH.

More preferably, the oxygen permeability of a 20 micrometer thermoplastic polyurethane layer according to an embodiment according to the invention is at most 1.5 cc·mm/m2·day·atm at 23° C. and 60% RH, still more preferably at most 1.0 cc·mm/m2·day·atm at 23° C. and 60% RH, most preferably at most 0.5 cc·mm/m2·day·atm at 23° C. and 60% RH.

A thermoplastic polyurethane with gas barrier characteristics better than polyethylene terephthalate measured under the same circumstances, has the advantage that an improved shelf life of oxygen-sensitive food becomes accessible.

Barrier measurements are preferably realised as follows.

### Measurement of Carbon Dioxide Loss

The permeability of carbon dioxide by a sample is determined by measuring the loss of CO2 of a sample in the period under controlled circumstances. The measurements of carbon dioxide are based on the gas laws of Henry and Dalton and the temperature of the liquid. The CO2 pressure is measured in the liquid-free zone of a drink bottle (headspace) by means of a LAB.CO laser measuring device of ACM. A laser beam with defined wavelength is directed and evaluated through the headspace in a receiver unit. The values are expressed in g CO2.L−1.

For example, a bottle is filled with tap water, so that sufficient space is left in the headspace for realizing measurements. The bottle is carbonized to 6.0±0.5 g·L−1. Subsequently, this bottle is placed in a LAB.SHAKE-overhead shaker with 8 rpm and rotated 50 times to obtain the correct pressure in the headspace. After shaking, the content of CO2 is determined as described. The samples are stored at room temperature in a dark cabinet.

### Oxygen Measurement

The permeability of oxygen by a sample is determined by measuring the penetration of oxygen in a sample which is poor of oxygen in the period under controlled circumstances. Dissolved oxygen is measured by means of the PreSens Fibox 3 Trace non-invasive oxygen measurement device.

Bottles are filled with demineralized water until a controlled headspace volume of 10 ml has been obtained. 0.5 ml of biocide is added to avoid the formation of algae. Oxygen is released from the bottles by transfer with nitrogen gas until an oxygen level between 0.1 and 0.5 ppm has been obtained. The samples are measured for 30 seconds and the average content of oxygen in this interval is calculated. Samples are mostly stored in a dark cabinet at 30° C.

### Accelerated Oxygen Measurement

A circular test plate with a diameter of 9.5 cm is placed in a measuring cell separating two chambers. The upper chamber is filled with 2 bars of pure oxygen, while the lower chamber is flushed and filled with 1 bar of nitrogen gas. The oxygen level in the lower chamber is measured by means of a PreSens Fibox 3 Trace non-invasive oxygen measurement device. The samples are measured for 30 seconds and the average content of oxygen in this interval is calculated. The overpressure in the upper cell causes an accelerated permeation of oxygen in the lower chamber.

In a second aspect, the invention provides for a packaging object comprising a thermoplastic polyurethane according to an embodiment of the invention. Said packaging object is preferably a hollow packaging object with stiff walls, such as a container or a bottle. In an alternative embodiment, the packaging object is a film.

A hollow packaging object according to an embodiment of the invention, preferably, has a multi-layer structure in which said thermoplastic polyurethane with barrier characteristics is provided as a layer, preferably, the layer of thermoplastic polyurethane is provided between two layers of plastic material, in which the two layers of plastic material are no thermoplastic polyurethane.

Said hollow packaging object with stiff walls is preferably made of a polyethylene, a polypropylene or a polyester plastic material and a thermoplastic polyurethane according to an embodiment of the invention.

A hollow packaging object according to an embodiment of the invention, preferably, has a multi-layer structure in which said thermoplastic polyurethane with gas barrier characteristics is provided as a layer between two layers of either a polyethylene, a polypropylene of a polyester plastic material. Said polyester plastic material is preferably a polyethylene terephthalate material.

Preferably, a hollow packaging object according to an embodiment of the invention is a packaging container obtained by blow moulding or stretch blow moulding a hollow preform for said packaging container.

Preferably, said hollow packaging object has a 20 micrometer thermoplastic polyurethane gas barrier layer with an oxygen permeability of at most 1.6 cc·mm/m2·day·atm at 23° C. and 60% relative humidity (RH).

More preferably, said hollow packaging object is a bottle made of PET comprising a thermoplastic polyurethane intermediate layer according to an embodiment of the invention. A bottle based on a PET/TPU composition has the advantage that it has no haziness as known from PET bottles with nylon-MXD6 intermediate layer. Moreover, the inventors have found that the PET/TPU bottles are more appropriate for mechanical recycling than PET/nylon-MXD6 bottles because they do not turn yellow as is the case for PET/nylon-MXD6 bottles.

In a third aspect, the invention provides a method for fabricating a thermoplastic polyurethane according to an embodiment of the invention, the method comprising the following steps:
(I) reactive extrusion of a reaction mixture at least comprising:
   (a) at least one cyclic polyisocyanate, and
   (b) at least one polyol,
characterised in that
the stoichiometric amount of isocyanate groups in the at least one cyclic polyisocyanate to the stoichiometric amount of isocyanate reactive groups in the at least one polyol is higher than 1, preferably situated between 1.01 and 1.10.

In a preferred embodiment of a method according to the invention, the reactive extrudate obtained under (I) is post-treated thermally (II) until the free isocyanate groups have substantially disappeared based on the absence of an NCO signal in a FTIR analysis of the thermally post-treated material.

Said thermal post-treatment preferably consist of an exposure of the thermoplastic polyurethane to 100° C. for at least 1 hour, preferably in a vacuum. Preferably, the vacuum is lower than 100 mbar.

Preferably, the at least one cyclic polyisocyanate and the at least one polyol are dosed in a fluid state to an extruder for reactive extrusion.

Preferably, said at least one cyclic polyisocyanate and said at least one polyol are in a fluid state at 25° C. and 1 atm.

Preferably, the at least one polyol is a mixture of diethylene glycol and triethylene glycol, more preferably a mixture of 30 mass % of triethylene glycol and 70 mass % of diethylene glycol expressed with respect to the total mass of the mixture.

Preferably, the at least one polyisocyanate used in a method according to an embodiment of the invention is 4,4′-methylene diphenyl diisocyanate, abbreviated MDI, or 2,4′-methylene diphenyl diisocyanate, abbreviated as 2,4′-MDI.

Preferably, the post-treatment under step (II) is maintained until the thermoplastic polyurethane contains a residual content of water of at most 800 ppm. More preferably, the residual content of water is at most 650 ppm, still more preferably at most 500 ppm, most preferably at most 400 ppm, still most preferably at most 200 ppm.

The thermoplastic extrudate obtained in a method according to an embodiment of the invention is preferably processed to a hollow packaging object. Preferably, the hollow packaging object is selected from a bottle, a cup, a bowl, a container or a tank. Most preferably, the hollow packaging object is a bottle.

Preferably, the processing is the provision of a layer of thermoplastic polyurethane.

In a further aspect, the invention provides for a method for producing a plastic packaging object, comprising:
providing a thermoplastic polyurethane according to an embodiment of the invention;
injecting said thermoplastic polyurethane thereby providing the plastic packaging object.

A method according to an embodiment of the invention for the production of a plastic object such as a bottle or a container is preferably:
injection moulding of a polyethylene, polypropylene and/or a polyester together with said thermoplastic polyurethane to a preform for the bottle or the container,
cooling down of the preform to a temperature below 50° C.,
transporting the cooled-down preform to a device for blow moulding or stretch blow moulding of bottles and containers,
during the transport, heating the preform to a temperature appropriate for deformation of the preform to a bottle or container by blowing or stretch blowing,
blow moulding or stretch blow moulding of the heated preform for forming said bottle or container.

Said selection of the temperature for deforming the preform is preferably based on the glass transition temperature of the thermoplastic polyurethane according to an embodiment of the invention and the plastic material which has been selected for the co-injection moulding.

Preferably, said heating temperature for a preform is situated between 100° C. and 130° C., more preferably between 110° C. and 120° C. The heating temperature is measured with infra red at the preform surface.

In the processing of the thermoplastic polyurethane in a co-injection application, preferably, a material with Tg is selected in such way that is deviates by less than 20° C., more preferably less than 19° C., still more preferably less than 18° C., most preferably less than 17° C. from the Tg of the plastic material which is injected together with the thermoplastic polyurethane.

This small difference in Tg has the advantage that the TPU and the plastic behave similarly in the glass transition phase at the processing, that there are less temperature tensions and that breakage is drastically reduced.

The result is a material which can be processed in a two-phase co-injection stretch blow moulding process together with PET. The Tg value ensures an improved compatibility with PET. This results, at the production of PET bottles in which the barrier material is processed, in less loss because of breakage of the bottles. The Tg selection is advantageous for avoiding delamination between the TPU and PET.

In an alternative method for the production of a bottle or container, the method is as follows:
extrusion moulding of a polymer composition until
formation of the bottle or the container, in which the polymer composition comprises a thermoplastic polyurethane according to an embodiment of the invention.

A packaging article with a multi-layer structure is preferably produced, without using tie layers.

In a last aspect, the invention provides a method for producing a film comprising a thermoplastic polyurethane according to an embodiment of the invention, characterised in that an extrudable plastic material is co-extruded with the thermoplastic polyurethane without using a tie layer for adhesion of a layer of the extruded plastic material to a layer of the co-extruded thermoplastic polyurethane.

The invention is further illustrated by means of examples. These examples are non-limiting.

### EXAMPLES

### Example 1: Impact of Polyol Mixture on Glass Transition Temperature

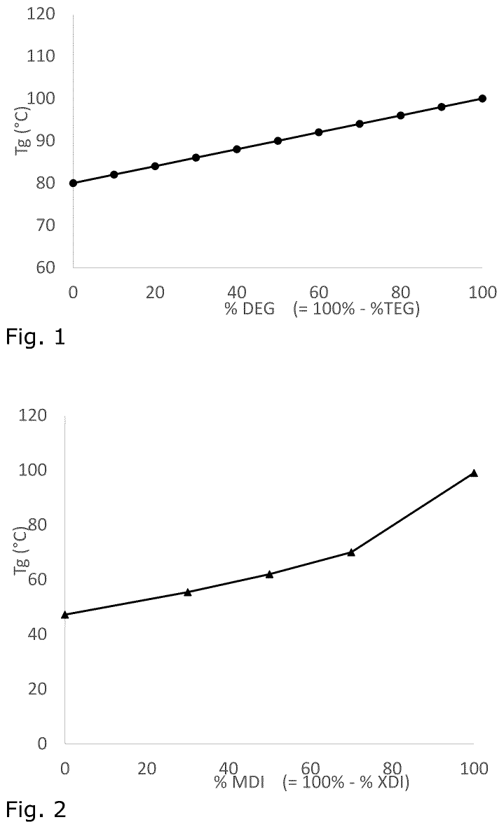

Thermoplastic polyurethanes were made based on MDI in combination with the polyols DG, TG or a mixture of DEG with TEG. The glass transition temperature of the obtained TPUs was measured with differential scanning calorimetry (DSC). The results were summarized in Table 1 and illustrated graphically in FIG. 1.

TABLE 1
100% of MDI

| % DEG | % TEG | Tg (° C.) |
|---|---|---|
| 100 | 0 | 100 |
| 90 | 10 | 98 |
| 80 | 20 | 96 |
| 70 | 30 | 94 |
| 60 | 40 | 92 |
| 50 | 50 | 90 |
| 40 | 60 | 88 |
| 30 | 70 | 86 |
| 20 | 80 | 84 |
| 10 | 90 | 82 |
| 0 | 100 | 80 |

The first measurement point was taken at a TPU obtained from a mixture comprising MDI as polyisocyanate, in the absence of another polyisocyanate (100% of MDI), and TEG as polyol, in the absence of another polyol (100% of TEG). Subsequently, measurements were realized on TPUs obtained from a mixture comprising only MDI as polyisocyanate, combined with a mixture of polyols based on TEG and DEG. The content of DEG was gradually increased. The end point in the curve on the graph is measured on a TPU obtained from a reaction mixture comprising only MDI as polyisocyanate and only DEG as polyol (100% of DEG). The Tg values increased linearly starting from Tg=80° C. (MDI+TEG) to Tg=100° C. (MDI+DEG).

The TPU material based on 100% of MDI and 100% of TEG with a Tg of 80° C. had no better barrier than PET, measured under the same conditions. This example is not part of the invention.

Glass transition temperatures between 82° C. and 98° C. for 100% of MDI with a mixture DEG/TEG were measured. These TPU materials according to the invention, based on DEG/TEG polyol mixtures could be processed well in an ISBM process for blow moulding bottles. The bottles did not break.

The TPU material based on 100% of MDI and 100% of DEG with a Tg of 100° C. could not be processed in an ISBM process for blow moulding bottles. The bottles broke. This example is not part of the invention.

### Comparative Example 1: Impact of Diisocyanate Mixture on Glass Transition Temperature

Thermoplastic polyurethanes were made based on DEG in combination with the diisocyanates XDI, MDI, or a mixture of XDI with MDI. The glass transition temperature of the obtained TPUs was measured with differential scanning calorimetry (DSC). The results were summarized in Table 2 and illustrated graphically in FIG. 2. Glass transition temperatures between 47° C. and 99° C. were measured.

TABLE 2
100% of DEG

| % XDI | 9% MDI | Tg (° C.) |
|---|---|---|
| 100 | 0 | 47.2 |
| 70 | 30 | 55.4 |
| 50 | 50 | 62 |
| 30 | 70 | 70 |
| 0 | 100 | 100 |

The TPUs with glass transition temperature below 60° C. could not be processed in an ISBM process. These materials are not part of the invention.

The TPU material based on 100% of MDI and 100% of DEG with a Tg of 100° C. could not be processed in an ISBM method for bottles. The bottles could not be blown. The preform broke.

### Example 2: Further Characterisation of TPUs

FTIR spectra of the TPUs from example 1 were registered with an ATR set-up of 600 to 4000 cm−1.

The solubility of TPUs was tested by adding a small piece of material to dimethylformamide (DMF). The dissolution of the TPU can last for 24 hours, depending on the composition and the molecular weight. A sample which did not dissolve completely (but only swelled) after 24 hours was considered as (partially) crosslinked. GPC was realized in tetrahydrofuran (THF). Samples were first dissolved in DMF. Refractive Index (RI) detection was used with a polystyrene standard for determining the molecular weight.

DSC scans were taken according to the following methods:
stabilisation for 10 minutes at 20° C.
scan up from 20 to 250° C. at a heating speed of 10° C./min
stabilisation for 2 minutes at 250° C.
scan down from 250 to 20° C. at a cooling speed of 10° C./min
stabilisation for 2 minutes at 20° C.
scan up from 20 to 300° C. at a heating speed of 10° C./min.

The value of the Tg was always read from the second heating scan in order to delete possible thermal history and an effect of the presence of water. The tangent lines to the DSC curve above and under the glass transition are determined. The section of an imaginary parallel line at equal distance between the two previous tangent lines, with the DSC curve, determines the glass transition temperature (midpoint).

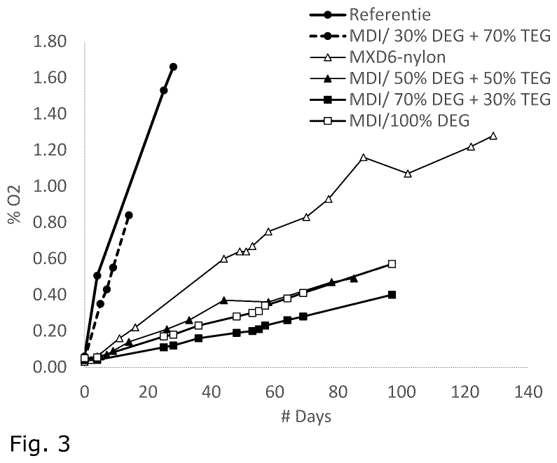

An example of a DSC curve taken on a thermoplastic polyurethane according to the invention, is shown in FIG. 3. The DSC curve taken in endothermic mode does not show a melting peak. The absence of a melting peak indicates a high amorphous content of the material.

MFI measurements were taken on devices of Zwick. Applied parameters for measurements:
Set temperature: 230° C. (unless stated otherwise)
Test load: 2.16 kg
Pre-beating time: 150 sec
Position pre-heating: 56 mm
Position/test time: 50 mm
Number of extrudates: 6
Delta s/delta t: 5 mm
Density: 1.1 kg/m3
Cutter: out-no use of stopper

### Water Content of the Raw Materials

The water content of the polyols which were used at the synthesis of the TPU were systematically measured with the Karl-Fischer method and each batch containing more than 500-600 ppm of water was not used.

### Water Content of the TPUs

All measurements of the water content on TPUs were realized with Brabender Aquatrac devices. Preferably, the TPU has a water content below 800 ppm.

### Barrier Tests

For barrier tests on TPU materials, plates were made by pressing.

The procedure for pressing plates for barrier measurements is as follows. Approximately 4 g of TPU material with less than 200 ppm of water was placed between two flexible Teflon plates. The material was pressed at temperatures of about 200-230° C. and a pressure of 6 bar for 30 sec and 2 minutes. The use of dry TFU material prevents the formation of bubbles in the obtained plate. The use of Teflon plates ensures that the plate can be easily detached.

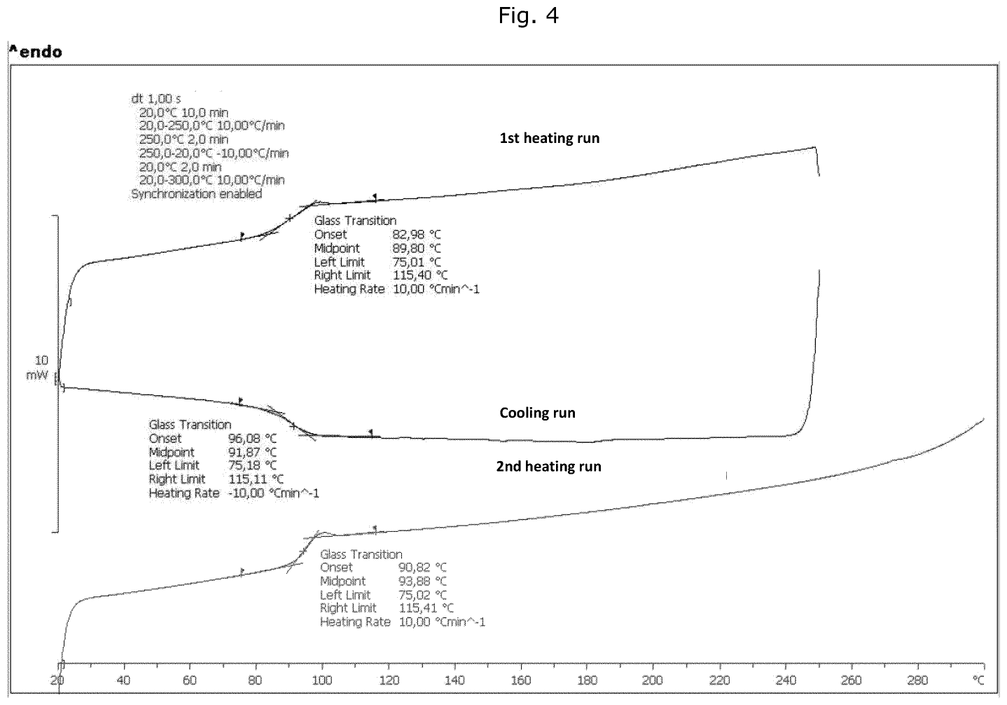

The results of the O2 permeability tests are shown in FIG. 4. The reference shows the oxygen permeability of PET. In the curve, the material is also shown which is used in this domain as a barrier material for PET. i.e. MXD6-nylon. The results show that a thermoplastic polyurethane obtained from MDI and a 70% DEG+30% TEG polyol mixture has particularly advantageous barrier characteristics. This can also be processed well as a barrier material in PET bottles, without breaking or delaminating.

### Example 3: Preparation of TPU with Single Polyol, Gas Barrier

A thermoplastic polyurethane was obtained by mixing the cyclic polyisocyanate MDI with 70 mass % of diethylene glycol (DEG) and 30 mass % triethylene glycol (TEG) without catalyser. The mixing and reaction of the cyclic polyisocyanate and the polyols was carried out in an extruder with double mixing screw. The stoichiometric amount of isocyanate groups in the cyclic polyisocyanate to the stoichiometric amount of isocyanate reactive groups in the at least one polyol (Index) was higher than 1, that is 1.03.

This material had a better gas barrier characteristic than PET measured under the same conditions. Tg was 94° C. The material did not break in an ISBM method.

Materials with an Index higher than 1 showed the desired characteristics. The Index was preferably 1.03-1.09.

### Comparative Example 3: Preparation of TPU with Single Polyol, No Gas Barrier

A thermoplastic polyurethane was obtained by mixing the cyclic polyisocyanate 4,4′-MDI with 100% of triethylene glycol (TEG) without catalyser. The mixing and reaction of the cyclic polyisocyanate and polyol was carried out in an extruder with double mixing screw. The index of the resulting TPU product according to the invention was 1.00. This material had no better gas barrier characteristic than PET measured under the same conditions. Tg 80° C.

### Example: Bottle Production

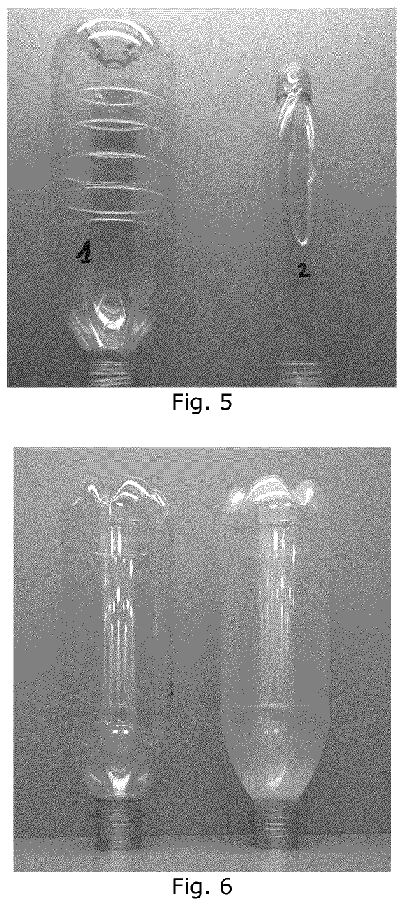

The injection moulding of preforms for bottles and the stretch blow moulding of bottles took place with techniques that are well-known by the skilled worker. The results of the test are shown in FIG. 5

The bottle shown on the left is based on a co-extrusion of PET with a TPU with Tg in the range of 60-98° C. The result is a correctly blown bottle with a TPU layer which adheres well to the PET material.

The bottle shown on the right is based on a co-extrusion of PET with a TPU with Tg outside the range of 60-99.5° C. (100% DEG, 100% MDI). The result is a broken bottle.

Additionally, a bottle was obtained by stretch blow moulding from a PET/TPU blend compared to a bottle obtained by stretch blow moulding from a PET/nylon-MXD6 blend. The results are shown in FIG. 6. Both bottles have barrier characteristics. The bottle based on the PET/TPU blend is clear. The bottle with nylon-MXD6 is hazy.

### Example 5: Impact on Recycling

The behaviour of a material and the suitability for mechanical recycling is evaluated with respect to two aspects, that is colour (yellow aspect) and haziness.

As reported in example 4, bottles with a thermoplastic polyurethane intermediate layer did not have any haziness.

A bottle based on a PET/TPU blend according to the invention and a bottle based on a PET/nylon-MXD6 blend according to the state of the art were ground to snips. On these snips, an oven test was realized, according to the Quick Test QT500 protocol of the European PET Bottle Platform, February 2010.

The snips of the PET/TPU blend did not turn yellow after the test. The snips of the PET/nylon-MDX6 blend did turn yellow.

It was concluded that the PET/TPU blend has the advantage of being compatible with the mechanical recycling process of PET bottles. This is advantageous for the recycling of the bottles.

1.-26. (canceled)

27. A thermoplastic polyurethane obtained from a reaction mixture comprising:
(a) at least one cyclic polyisocyanate, and
(b) at least one polyol,
in which the thermoplastic polyurethane has gas barrier characteristics which are better than the gas barrier characteristics of polyethylene terephthalate (PET) measured under the same circumstances,
wherein the thermoplastic polyurethane is an essentially amorphous material based on the absence of a melting peak in a DSC curve, and
the thermoplastic polyurethane has a glass transition temperature Tg situated between 60° C. and 99.5° C. in a DSC curve, and
both curves were obtained with differential scanning calorimetry (DSC) as mentioned in the description.

28. The thermoplastic polyurethane of claim 27, wherein said glass transition temperature Tg is between 65° C. and 99° C.

29. The thermoplastic polyurethane of claim 27, with the exclusion of the cyclic polyisocyanates 1,3-xylyne diisocyanate (MXDI) and cyclohexane diisocyanate (CHDI).

30. The thermoplastic polyurethane of claim 27, wherein the at least one cyclic polyisocyanate is the aromatic polyisocyanate 4,4′-methylene phenyl diisocyanate, abbreviated as MDI.

31. The thermoplastic polyurethane of claim 27, wherein the thermoplastic polyurethane was obtained by reactive extrusion of the at least one cyclic polyisocyanate with the at least one polyol, in which the stoichiometric amount of isocyanate groups in the at least one cyclic polyisocyanate to the stoichiometric amount of isocyanate reactive groups in the at least one polyol is situated between 1.01 and 1.10.

32. The thermoplastic polyurethane of claim 27, wherein the reaction mixture does not contain more than two polyols with a molecular weight situated between 100 and 200 g/mol.

33. The thermoplastic polyurethane of claim 32, wherein the reaction mixture contains diethylene glycol and triethylene glycol.

34. The thermoplastic polyurethane of claim 27, wherein a Melt Flow Index (MFI) measured at a test load of 2.16 kg between 10 and 45 g/10 min at 230° C.

35. The thermoplastic polyurethane of claim 27, wherein the thermoplastic polyurethane is substantially free of non-reacted polyisocyanate groups based on the absence of an NCO signal in a Fourier Transform Infra-red analysis.

36. The thermoplastic polyurethane of claim 27, wherein a 20-micrometer thermoplastic polyurethane layer has an oxygen permeability of at most 1.6 cc·mm/m2·day·atm at 23° C. and 60% RH.

37. A packaging object comprising a thermoplastic polyurethane of claim 27, in which the packaging object is a hollow packaging object with stiff walls or a film.

38. A hollow packaging object of claim 37, wherein the packaging object has a multi-layer structure in which said thermoplastic polyurethane with gas barrier characteristics is provided as a layer.

39. The hollow packaging object of claim 37, wherein the hollow packaging object is a packaging container obtained by the blow moulding or stretch blow moulding of a hollow preform of said packaging container.

40. The hollow thermoplastic polyurethane of claim 37, wherein a 20-micrometer thermoplastic polyurethane gas barrier layer has an oxygen permeability of at most 1.6 cc·mm/m2·day·atm at 23° C. and 60% RH.

41. A method for producing a thermoplastic polyurethane of claim 27, the method comprising the following steps:
(I) reactive extrusion of a reaction mixture at least comprising:
(a) at least one cyclic polyisocyanate, and
(b) at least one polyol,
wherein the stoichiometric amount of isocyanate groups in the at least one cyclic polyisocyanate to the stoichiometric amount of isocyanate reactive groups in the at least one polyol is higher than 1.

42. The method of claim 41, wherein the reactive extrudate obtained under step (I) is post-treated thermally until the free isocyanate groups have substantially disappeared based on the absence of an NCO signal in a Fourier Transform Infra-red analysis of the thermally post-processed material.

43. The method of claim 42, wherein said thermal post-treatment consist of an exposure to the thermoplastic polyurethane for at least 1 hour at 100° C.

44. The method of claim 41, wherein the at least one cyclic polyisocyanate and the at least one polyol are dosed in a fluid state to an extruder for reactive extrusion.

45. The method of claim 41, wherein the at least one polyol is a mixture of diethylene glycol and triethylene glycol.

46. The method of claim 41, wherein the at least one polyisocyanate is 4,4′-methylene phenyl diisocyanate (MDI).
